(19) United States
(12) Patent Application Publication
(10) Pub. No.: US 2006/0000772 A1
(43) Pub. Date: Jan. 5, 2006

(54) Separation apparatus and separation method

(76) Inventors: Toru Sano, Tokyo (JP); Masakazu Baba, Tokyo (JP); Kazuhiro Iida, Tokyo (JP); Hisa Kawaura, Tokyo (JP); Noriyuki Iguchi, Tokyo (JP); Hiroko Someya, Tokyo (JP); Minoru Asogawa, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/536,798

(22) PCT Filed: Nov. 28, 2003
(86) PCT No.: PCT/JP03/15260

§ 371 Date: May 27, 2005

(30) Foreign Application Priority Data
Nov. 29, 2002 (JP) 2002-349301

(51) Int. Cl. B01D 15/08

(52) U.S. Cl. 210/635; 210/638; 210/656; 436/161

(57) ABSTRACT

A channel (103) is formed in a substrate (101), and a portion of the channel (103) is provided with a separating portion (107). A number of pillars are formed in the separating portion (107), and an adsorptive substance layer having an adsorptive substance, which exhibits a specific interaction for a specific substance, immobilized on the surface thereof, is formed. Once a sample is introduced into the channel (103), the specific substance is adsorbed on the adsorptive substance layer to be separated from other components. After washing the inside of the channel (103) with a buffer solution, the specific substance is desorbed from the adsorptive substance layer by flowing a eluting solution through the channel (103) and the specific substance is recovered.

### BACKGROUND OF THE INVENTION

1. Field of the Invention

The present invention relates to a separation apparatus, a separation method and a mass spectrometry system, and more particularly relates to a separation apparatus that utilizes specific interactions between substances.

2. Related Art of the Invention

Affinity chromatography is a chromatography, in which a substance having specific interaction with a substance to be separated and purified is immobilized onto insoluble carriers to produce affinity adsorbents, and the resultant affinity adsorbents are charged into a column, and a target substance in a sample solution is adsorbed on the affinity adsorbent, thereby being separated. The affinity chromatography is a method of separating a component by utilizing the specific interaction between substances and particularly useful for separating and purifying a bio-derived material.

However, the affinity chromatography that involves filling the column is not always suitable in terms of a design for efficiently separating a very small amount of a sample.

In the meanwhile, researches and developments for a microchip having separation and analytical functions for bio-derived materials are actively conducted. In these microchips, fine flow channels for the separation or the like are provided by using a fine processing technology to allow a separation by introducing trace amount of sample into the microchips.

In the technology that utilizes such a microchip, an effort for adopting the technology of the affinity chromatography is proposed (patent document 1). In such apparatus, a region filled with the affinity adsorbent having a carrier of beads and so on is provided in the flow channel, and the target component is adsorbed onto the affinity adsorbent when the sample containing the target component is flowed in the flow channel. However, in such configuration, similarly as in the case of the affinity chromatography utilizing the conventional column, when the filling rate of the affinity adsorbent is higher the affinity adsorbents can not be arranged with sufficient intervals therebetween, and, in turn, the entire surface of the affinity adsorbent cannot be involved in the adsorption with the target substance, thereby causing a problem of deteriorating the separation efficiency.

Moreover, while it is described that the apparatus described in patent document 1 may include a channel wall of an insoluble carrier, the surface area is smaller in the case of utilizing only the wall, and thus the required length of the channel is increased when sufficient amount of the affinity adsorbent is provided therein.

Further, it is necessary to recover the target substance in such a way that the target substance is adsorbed onto the affinity adsorbent and thereafter the target substance is desorbed from the affinity adsorbent, and since the solution containing higher concentration of a salt solution or an organic solvent should be used in this occasion, problems of generating an irreversible denaturalization in the conformation or an deactivation or the like of the target substance are occurred when the target substance includes a substance having higher-order structure such as a protein. Patent document 1: Published Japanese Translations of PCT International Publication for Patent Application No. 2002-502,597

### SUMMARY OF THE INVENTION

In view of the above-described situation, an object of the present invention is to provide an apparatus or a method for efficiently separating a specific substance in a sample by utilizing a specific interaction. In addition, another object of the present invention is to provide a smaller separation apparatus for efficiently separating and recovering trace amount of a specific substance. Moreover, further object of the present invention is to provide a separation apparatus or a separation method, in which a specific substance is desorbed after being adsorbed by a simple method thereby being recovered while maintaining higher activity. Additionally, yet further object of the present invention is to provide a mass spectrometry system that is applicable to a biological sample.

According to the present invention, there is provided a separation apparatus, including: a substrate; a channel provided in the substrate and for flowing sample in the channel; a separating portion provided in the channel and for separating a specific substance in the sample; and a fine channel provided in the separating portion and having a width that is smaller than that of the channel, wherein a layer of an adsorptive substance is formed in the separating portion, the adsorptive substance selectively adsorbing or binding to the specific substance.

In the present invention, “selectively adsorbing or binding” indicates that only a subject substance adsorbs or binds to the detection substance and other substances included in the sample never adsorbs or binds thereto. Form of the adsorption or the binding is not limited, and even a physical interaction or a chemical interaction may also be employed. In addition, the selective adsorption or binding will be appropriately referred to as “specific interaction” as follows.

The separation apparatus according to the present invention is an apparatus that conducts a separation of a specific substance in a sample by utilizing a principle of affinity chromatography in a separating portion. Since the separation apparatus according to the present invention is configured to be provided with the separating portion in the channel formed in the substrate, once a sample containing a specific substance is introduced into the channel, selective adsorption or binding thereof onto a layer of an adsorptive substance formed in the separating portion can be achieved. Thus, the separation of the specific substance can be achieved by a simple operation.

In addition, by forming in the separating portion a fine channel having a narrower width than the channel, increasing the number of molecules of the specific substance that approaches to the adsorptive substance on the surface of the separating portion and thereby provides an interaction therewith can be achieved,. Therefore, the specific substance can efficiently be separated.

Since the separation apparatus according to the present invention is capable of conducting an affinity chromatography on a microchip, this can be incorporated in μ TAS. For example, the apparatus may have a configuration, in which the sample separated by the separating portion is communicated into a sample drying section, so that the separated sample is dried and recovered, and in addition, is presented for mass spectrometry or the like.

According to the present invention, there is provided a separation apparatus, including: a substrate; a channel provided in the substrate and for flowing sample in the channel; a separating portion provided in the channel and for separating a specific substance in the sample; and a protruding portion provided in the separating portion, wherein a layer of an adsorptive substance is formed in the separating portion, the adsorptive substance selectively adsorbing or binding to the specific substance.

Since the separation apparatus according to the present invention includes the protruding portion formed in the separating portion, increasing number of molecules of the specific substance that approaches to the adsorptive substance on the surface of the separating portion and provides an interaction therewith can be achieved. In addition, the width of the sample passage path in the separating portion can be adjusted by adjusting the geometry and the arrangement of the protruding portion. Accordingly, geometry of the separating portion can be optimized according to molecular size of the specific substance, and thus separation efficiency thereof can be improved as compared with a conventional method that involves filling the channel with carrier particles.

The separation apparatus of the present invention may further have a configuration, in which electrodes are provided in the separating portion and the channel, and the separation apparatus further comprises an electrical voltage applying unit that provides electrical voltage between the electrodes.

In addition, the separation apparatus of the present invention may further have a configuration, in which a protruding portion is provided in the separating portion, and an electrode is formed in the protruding portion. Having such additional configurations, a specific substance charged with electricity can be guided to the separating portion with higher efficiency. Further, when the specific substance selectively adsorbed or bound to the adsorptive substance is desorbed in the separating portion, the polarity of electric potential provided to the electrodes can be controlled to facilitate the desorption, and thus a salt concentration or an organic solvent concentration in a solution for desorption that flows through the channel can be reduced. Accordingly, even in a case of employing a protein as a specific substance, deactivation and denaturation thereof can be inhibited.

The separation apparatus of the present invention may further have a configuration, in which a combination of the specific substance and the adsorptive substance is any one of: an antigen and an antibody; an enzyme and a substrate; an enzyme and a substrate derivative; an enzyme and an inhibitor; a sugar and a lectin; a DNA and a DNA; a DNA and an RNA; a protein and a nucleic acid; a metal and a protein and a ligand and a receptor. Having such configuration, the specific substance can be separated from the biological sample. In this occasion, since the separation apparatus according to the present invention has the configuration, in which the channel is formed in the substrate and has the configuration that is suitable for separating a trace amount of sample, the separation can certainly be carried out.

The separation apparatus of the present invention may further have a configuration, in which the adsorptive substance is provided through a spacer on the surface of the substrate. By providing the spacer, a preferable space is formed between the adsorptive substance and the substrate, and thus the adsorption or the binding of the specific substance can be formed with higher efficiency. In addition, by providing the spacer with hydrophilic molecule, the surface of the separating portion is coated with hydrophilic graft chain, and thus non-specific adsorption of unnecessary components except a specific substance to the separating portion surface can be inhibited.

According to the present invention, there is provided a separation method, comprising: in a separating portion of a separation apparatus including a channel provided in a substrate, a separating portion provided in the channel and a fine channel provided in the separating portion and having a width that is smaller than that of the channel, introducing a liquid containing an adsorptive substance into the channel while applying an electrical voltage of different polarity than that of the adsorptive substance to said separating portion to cause an adsorption onto the separating portion, the adsorptive substance being capable of selectively adsorbing or binding to a separating target substance; introducing a sample containing the separating target substance into the channel to cause a selective adsorption or binding to the adsorptive substance; and introducing an eluting solution into the channel to elute and recover the separating target substance, the eluting solution being capable of causing an elution of the separating target substance from the adsorptive substance.

In addition, according to the present invention, there is provided a separation method, comprising: in a separating portion of a separation apparatus including a channel provided in a substrate, a separating portion provided in the channel and a protruding portion provided in the separating portion, introducing a liquid containing an adsorptive substance into the channel while applying an electrical voltage of different polarity than that of the adsorptive substance to said separating portion of said separating apparatus to cause an adsorption onto the separating portion, the adsorptive substance being capable of selectively adsorbing or binding to a separating target substance; introducing a sample containing the separating target substance into the channel to cause a selective adsorption or binding to the adsorptive substance; and introducing an eluting solution into the channel to elute and recover the separating target substance, the eluting solution being capable of causing an elution of the separating target substance from the adsorptive substance.

According to the separating method according to the present invention, the adsorption of the adsorptive substance, the introduction of the sample, and the elution and the recovery of the specific substance in the sample are conducted while applying an electrical voltage to the separating portion, thereby allowing to simply and certainly conduct the separation of the specific substance without the need for immobilizing the adsorptive substance to the substrate using a coupling agent. For example, when the adsorptive substance is negatively charged, the adsorptive substance can be adsorbed to the separating portion by providing a positive electric potential to the separating portion.

According to the present invention, there is provided a mass spectrometry system, comprising: a separating unit that separates a biological sample according to molecular size or a property of the biological sample; a pretreatment unit that conducts a pretreatment including an enzymatic digestion treatment of the sample separated by the separating unit; a drying unit that dries the pretreated sample; and amass spectrometry unit that achieves amass spectrometry of the sample after drying, wherein the separating unit contains the aforementioned separation apparatus. Here, the biological sample may be one extracted from a living body, or synthesized one.

Here, any combination of above-described elements, or any mutual conversion of the elements and/or expressions of the present invention between method and apparatus is also effective as an aspect of the present invention.

As have been described above, according to the present invention, by comprising a channel provided in a substrate, a separating portion provided in the channel and a fine channel provided in the separating portion and having a width that is smaller than that of the channel, and by forming in the separating portion a layer of an adsorptive substance selectively adsorbing or binding to the specific substance, the separation apparatus or the method for separating the specific substance in the sample with higher efficiency utilizing a specific interaction can be achieved. In addition, according to the present invention, the smaller separation apparatus for separating and recovering trace amount of the specific substance with higher efficiency can be achieved. Further, according to the present invention, the separation apparatus or the separating method for adsorbing the specific substance and thereafter desorbing thereof with a simple method and recovering thereof with the condition of maintaining higher activity can be achieved. Further, according to the present invention, the mass spectrometry system that is applicable to biological samples can be achieved.

### BRIEF DESCRIPTION OF THE DRAWINGS

The above and other objects, features and advantages of the present invention will be more apparent from the following description and the annexed drawings, in which:

FIG. 1 is a top view, illustrating a configuration of a separation apparatus according to the present embodiment;

FIG. 2 is a drawing, illustrating a configuration of a separation region of the separation apparatus of FIG. 1;

FIG. 3 is a perspective view, illustrating a configuration of a separating portion of the separation apparatus of FIG. 1;

FIG. 4 is a drawing for describing a configuration of a surface of the separation apparatus of FIG. 1;

FIG. 5 is a drawing for describing a configuration of a pillar surface of the separation apparatus of FIG. 1;

FIG. 6 is a drawing, illustrating a configuration of a separation apparatus according to the present embodiment;

FIG. 7 is a drawing for describing a configuration of a fluid reservoir of separation apparatus of FIG. 6;

FIG. 8 is a drawing for describing a configuration of B-B′ direction of the fluid reservoir of FIG. 7;

FIG. 9 is a drawing, illustrating a configuration of a separating portion of a separation apparatus according to the present embodiment;

FIG. 10 is a drawing, illustrating a configuration of a separating portion of the separation apparatus of FIG. 1;

FIG. 11 is a schematic drawing illustrating a configuration of a mass spectrometry apparatus;

FIG. 12 is a drawing, illustrating a configuration of a separation apparatus according to the present embodiment;

FIG. 13 is a drawing, illustrating a configuration of a dry portion of the separation apparatus of FIG. 12;

FIG. 14 is a process cross-sectional view, illustrating a method for manufacturing a separation apparatus according to the present embodiment;

FIG. 15 is a process cross-sectional view, illustrating a method for manufacturing a separation apparatus according to the present embodiment;

FIG. 16 is a process cross-sectional view, illustrating a method for manufacturing a separation apparatus according to the present embodiment;

FIG. 17 is a process cross-sectional view, illustrating a method for manufacturing a separation apparatus according to the present embodiment;

FIG. 18 is a drawing illustrating another example of the separation apparatus;

FIG. 19 is a drawing illustrating another example of the separation apparatus;

FIG. 20 is an enlarged view of the vicinity of sample quantification tube of the separation apparatus illustrated in FIG. 18;

FIG. 21 is a detail view of the separation apparatus illustrated in FIG. 19; and

FIG. 22 is a block drawing of mass spectrometry systems including the separation apparatus of the present embodiment.

### PREFERRED EMBODIMENTS OF THE INVENTION

Preferable embodiments will be described as follows in reference to the annexed figures. In all figures, identical numeral is assigned to an element commonly appeared in the figures, and the detailed description thereof is not presented in the following descriptions.

### First Embodiment

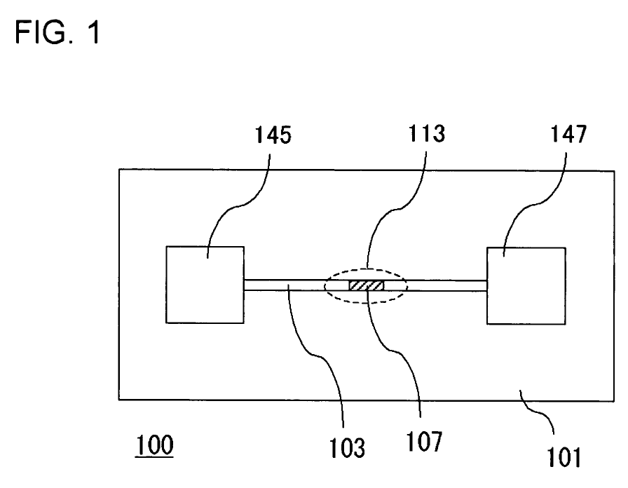

FIG. 1 is a top view of a separation apparatus 100 according to the present embodiment. In separation apparatus 100, a channel 103 is provided on a substrate 101, and a separating region 113 including a separating portion 107 is formed in a part of the channel 103. Further, both ends of the channel 103 are communicated with a sample introduction portion 145 and a fluid reservoir 147, respectively.

Here, an upper surface of the channel 103 may be coated with a coating member. Drying of a liquid sample is suppressed by providing the coating member on the upper surface of the channel 103. Moreover, when a component in the sample includes a substance having a higher-order structure such as a protein, irreversible denaturation of the component in the gas-liquid interface is suppressed by tightly sealing the inside of the channel 103 by using a coating member having a hydrophilic surface.

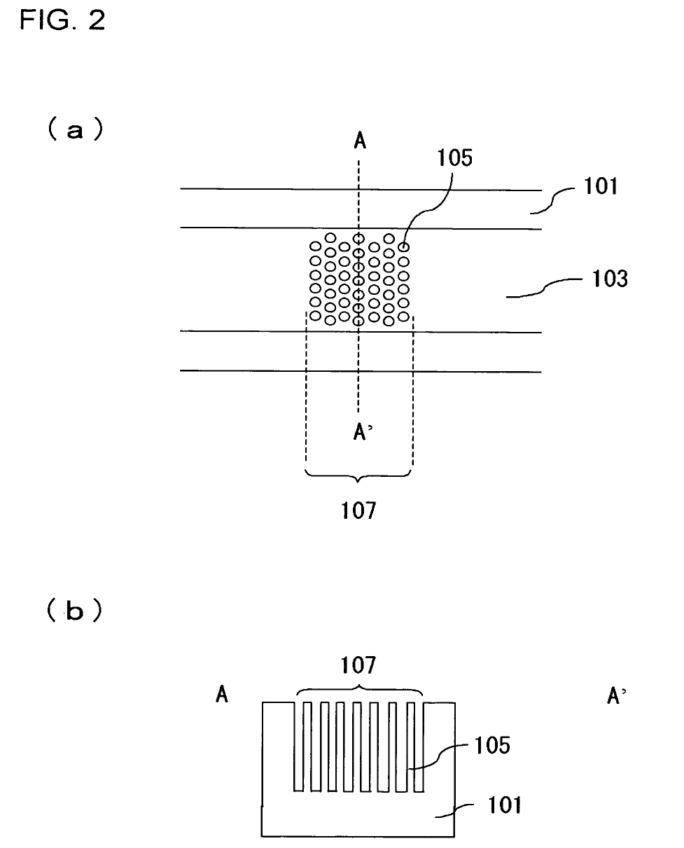

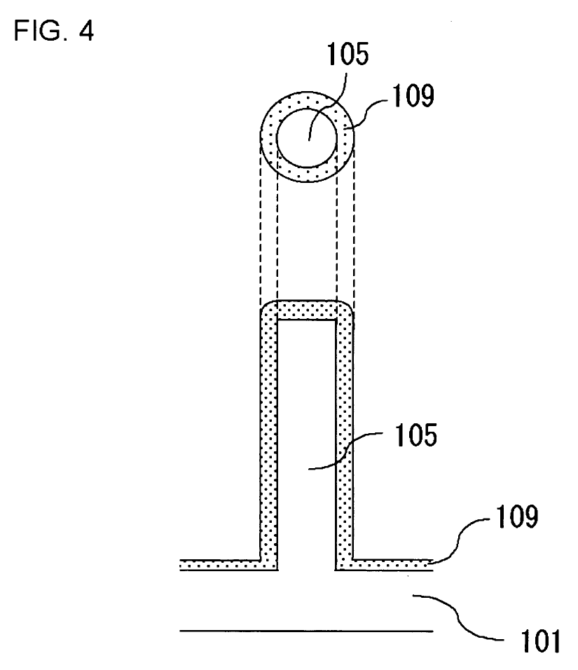

FIG. 2 is an enlarged view of the separation region 113 in the separation apparatus 100. FIG. 2(a) is a top view, and FIG. 2(b) is a cross sectional view of A-A′ direction of FIG. 2(a). In separating portion 107, pillars 105 are regularly formed at regular intervals in the channel 103, and liquid flows through spaces between the pillars 105. Since an adsorptive substance layer is formed on the surface of the pillar 105 as later-described for FIG. 4, a specific component in the liquid sample can be selectively adsorbed or bound to the non-adsorptive substance on the surface of the pillar 105.

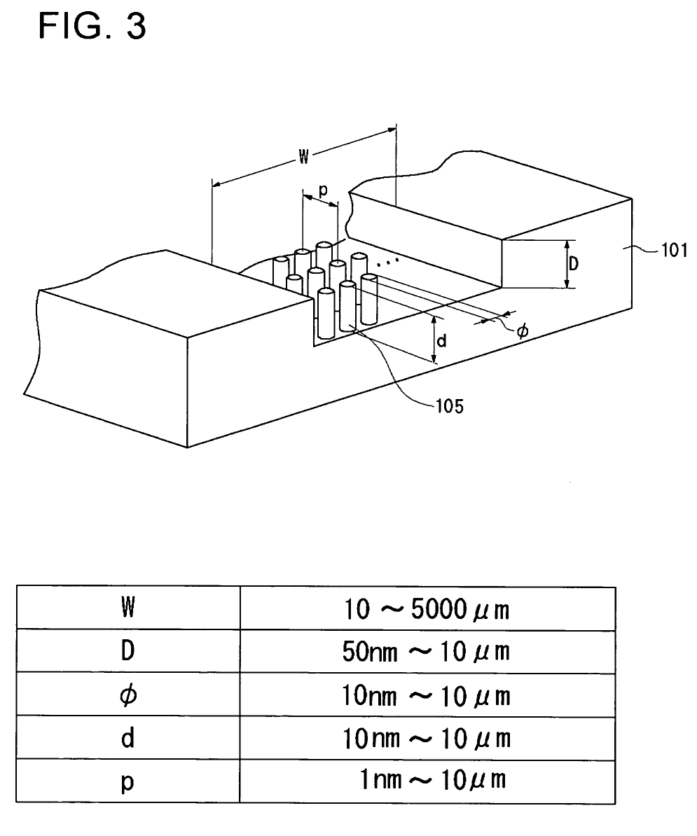

FIG. 3 is a perspective view, illustrating a configuration of the substrate 101 in the separating portion 107. In FIG. 3, W is a width of the channel 103 and D represents a depth of the channel 103, and p represents a diameter of the pillar 105, d represents a height of the pillar 105 and p represents a mean interval between adjacent pillars 105. Each of these dimensions can be, for example, within ranges described in FIG. 3. Furthermore, provided that a diameter of a molecule to be separated is R, it is preferable that R and p, D, or d satisfy the following conditions. Having such configuration, the specific substance A′ in the sample introduced into the separating portion 107 can effectively be in contact with the wall surface, thereby being separated.
P: 0.5R≦p≦50R
D: 5R≦D≦50R
D: R≦d≦50R.

FIG. 4 is a drawing for describing the configuration of the surface of the substrate 101. An adsorptive substance layer 109 is formed on the substrate 101. In other words, the adsorptive substance is immobilized on the surface of the substrate 101.

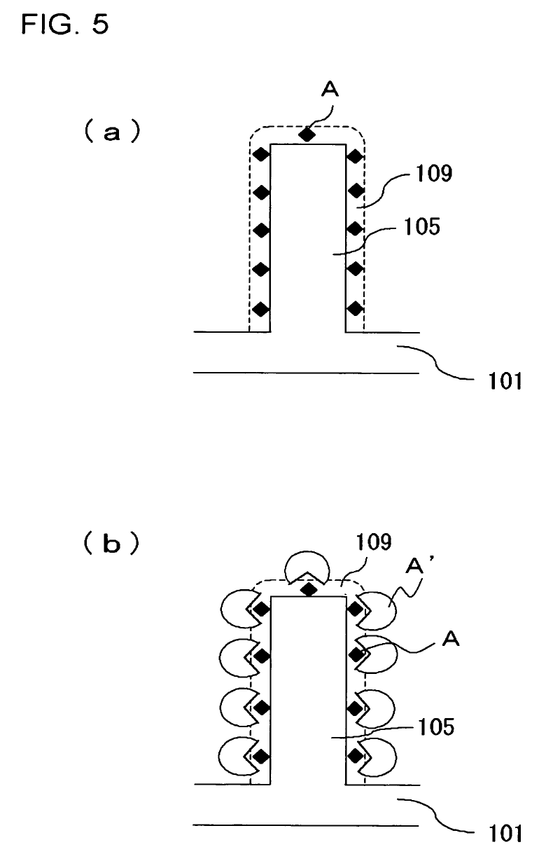

FIG. 5 is a drawing for describing a condition that that adsorptive substance A is immobilized in the adsorptive substance layer 109, taking the surface of the pillar 105 surface as an example.

In FIG. 5(a), low-molecular weight substances are immobilized on the surface of the pillar 105 as the adsorptive substance A. When a liquid sample containing specific substances A′ are introduced to such pillar 105, as illustrated in FIG. 5(b), the specific substance A′ in the liquid sample is selectively adsorbed or bound to the adsorptive substance A to form a complex. Accordingly, in the separation apparatus 100, only specific substance A′ having a specific interaction with the adsorptive substance A can be selectively adsorbed to the adsorptive substance layer 109, thereby being separated from other components in the sample.

In the separation apparatus 100, silicon is used as a substance of the substrate 101. Alternatively, for example, glass substances such as quartz or plastic materials and the like may be employed in place of silicon. The plastic materials include, for example, thermoplastic resins such as silicone resins, PMMA (polymethylmethacrylate), PET (polyethylene terephthalate), PC (polycarbonate) or the like and thermosetting resins such as epoxy resins or the like. Since the molding process for such types of substances can be easily conducted, the manufacturing cost for the drying apparatus can be reduced.

While the pillar 105 may be formed by, for example, etching the substrate 101 to provide a predetermined pattern, the manufacturing method is not particularly limited. Moreover, while the geometry of the pillar 105 of FIG. 2 is a cylinder, the geometry thereof is not limited to pseudo cylinders such as cylinder, pseudo cylinder and the like and may be: cones such as circular cone and elliptical cone; prisms such as triangular prism and quadratic prism; or pillar having other type of cross-sectional geometry and the like.

The adsorptive substance A provided in the adsorptive substance layer 109 and the specific substance A′ are selected from combinations of substances that provide selective adsorption or bonding. As such combinations,
(a) a ligand and a receptor,
(b) an antigen and an antibody,
(c) an enzyme and a substrate, an enzyme and a substrate derivative, or an enzyme and an inhibitor,
(d) a sugar and a lectin,
(e) a DNA (deoxyribonucleic acid) and an RNA (ribonucleic acid), or a DNA and a DNA,
(f) a protein and a nucleic acid, and
(g) a metal and a protein can be used, for example.
   In each of these combinations, one is a specific substance and the other is an adsorptive substance.

In the case of (a), hormones such as steroid, physiologically active substances such as neurotransmitter, drugs, other blood factors, cell membrane receptors such as insulin receptor, or proteins having affinity with the above-described receptor, glycoproteins, glycolipids or low-molecular weight substance and so on may be employed.

In the case of (b), antigens may be low-molecular weight substances such as so-called hapten, or polymer substances such as protein.

As examples of the antigen, for example, HCV antigen, tumor markers such as CEA and PSA, Human Immunodeficiency Virus (HIV), abnormal prion, and protein peculiar to Alzheimer's disease or the like, may be employed.

In the case of (c), for example, combination of: neuraminidase derived by influenza virus and inhibitor candidate thereof; reverse transcriptase of HIV virus and inhibitor candidate thereof; or HIV protease and inhibitor candidate thereof, or the like, may be employed.

In the case of (d), for example, combination of: N-acetyl-D-glucosamine and wheat germ lectin; or concanavalin A (ConA) and ConA receptor glycoprotein, or the like, may be employed.

In the case of (e), combination of: mutated DNA and complementary DNA for the mutated DNA, or the like, may be employed.

In the case of (f), for example, combination of: DNA binding protein and DNA, or the like, may be employed.

In the case of (g), for example, combination of: nickel and histidine tag (His-Tag), or the like, may be employed.

In addition, when coating member is provided on the upper portion of the channel 103, the substance thereof may be selected from, for example, same substances as used for the substrate 101. Similar substances as used for the substrate 101 may be employed, or different substances therefrom may also be employed.

Next, the method for separating the specific substance A′ using the separation apparatus 100 will be described.

Returning to FIG. 1, the liquid sample containing the specific substance A′ is injected to a sample introducing portion 145 and is spreaded to the channel 103 by utilizing a capillary effect or a pressing thereinto using a pump or the like. Flow rate of the liquid sample is, for example, within a range of from 10 nl/min to 100 μl/min. Then, as mentioned above in reference to FIG. 5, only specific substance A′ having a specific interaction with the adsorptive substance A is selectively adsorbed to the adsorptive substance layer 109 in the separating portion 107.

The components that are not adsorbed are guided to a fluid reservoir 147 with a solvent or a liquid that is a dispersion medium.

Next, a buffer solution and the like for washing the channel 103 flows through the sample introducing portion 145 to remove the components except the specific substance A′ staying in the channel 103. In this occasion, since the specific substance A′ and the adsorptive substance A are adsorbed or bound together by the specific interaction therebetween, these are not dissociated.

After the channel 103 is washed, the specific substance A′ is desorbed from the adsorptive substance A. As a desorption method, a method of introducing, for example, NaCl solution at a level of from 0.1 mol/l or more to 1 mol/l or less from the sample introducing portion 145 into the channel 103 may be employed. Furthermore, when the adsorptive substance A and the specific substance A′ are antigen and antibody respectively, a substance, which has a specific interaction with the adsorptive substance A and having larger binding constant for binding to the adsorptive substance A than that for binding to the specific substance A′, may also be introduced into the channel 103 as a competitive inhibitor to allow desorbing the specific substance A′. The desorbed specific substance A′ is introduced into the fluid reservoir 147, thereby being recovered.

As mentioned above, since the separation apparatus 100 includes the separation part 107 formed in the channel 103, the sample can be introduced into the channel 103, even if it is a very small amount, to separate and recover the specific substance A′. The operation thereof is simple and easy, as compared with the affinity chromatography using a column. Moreover, since the separation apparatus 100 is a disposable tip, washing of the separation apparatus 100 is not required, thereby definitely conducting the separation.

Next, the method for manufacturing the separation apparatus 100 will be described.

While formation of the channel groove 103 and the pillar 105 onto the substrate 101 may be conducted by etching the substrate 101 to provide a predetermined pattern, the formation method is not particularly limited.

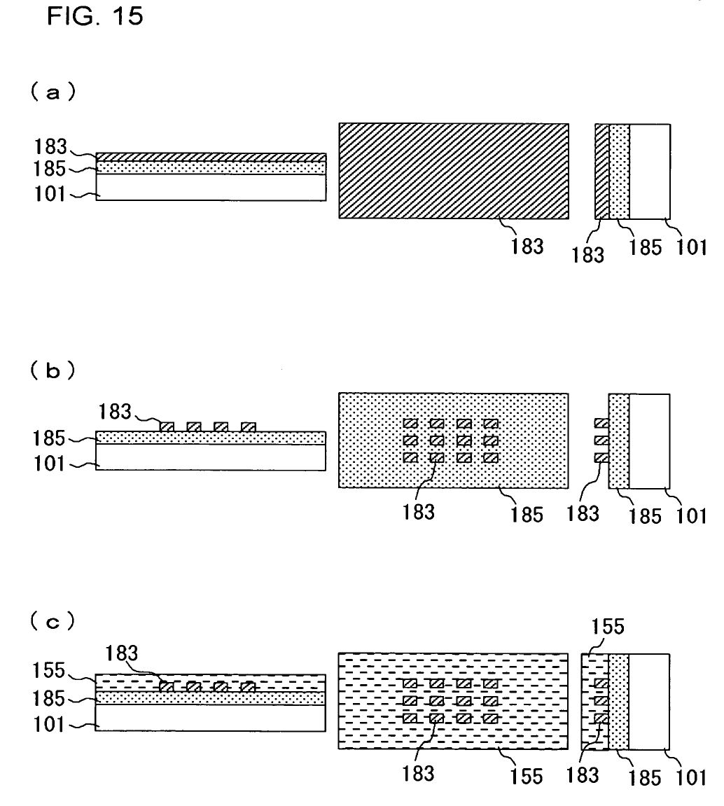

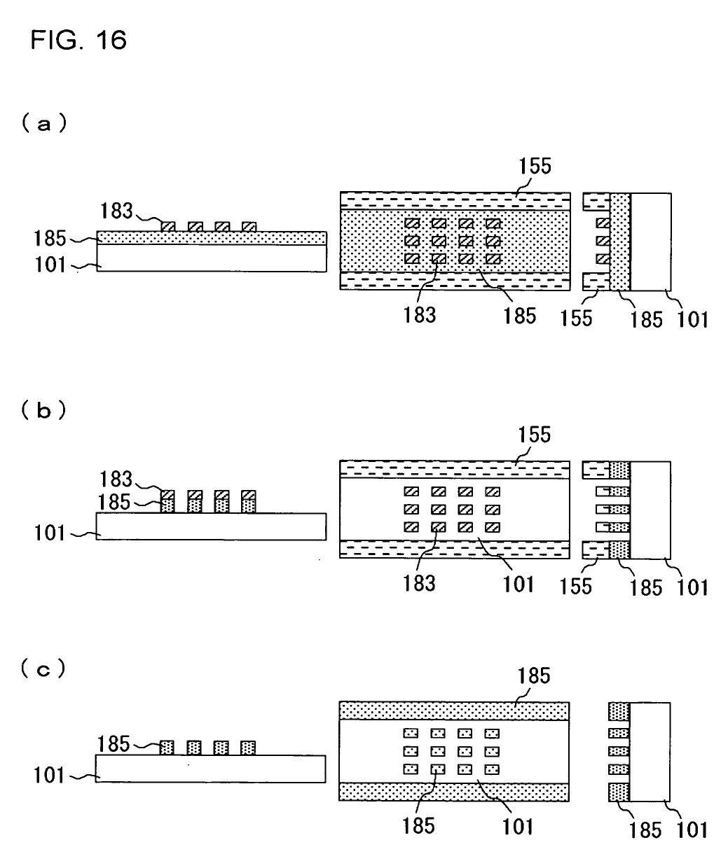

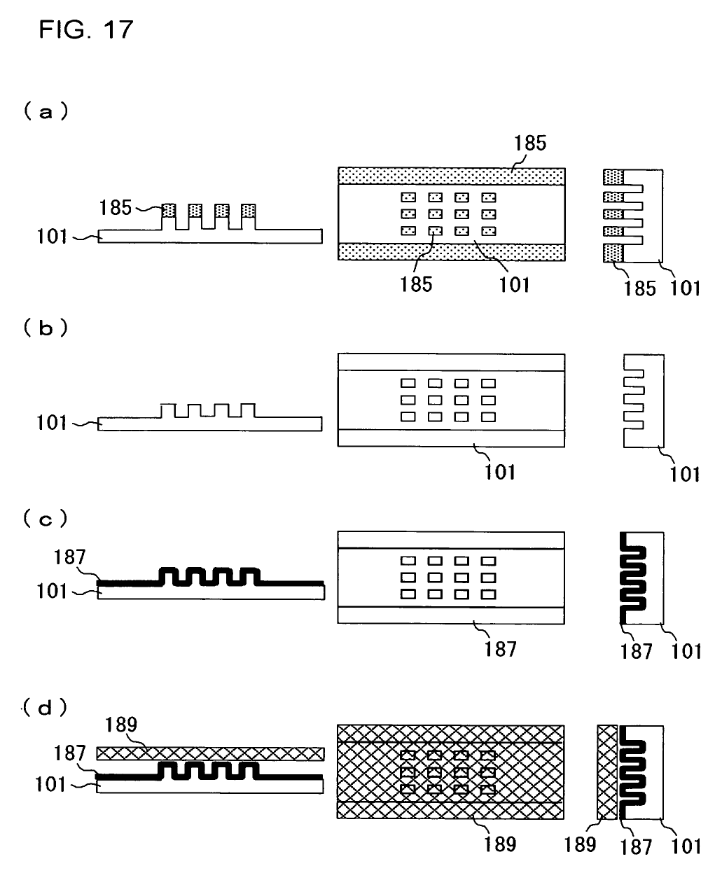

FIG. 15, FIG. 16 and FIG. 17 are process cross-sectional views, showing an example thereof. In each of the sub-drawings, middle drawing is a top view, and drawings in right and left are cross-sectional views. In this method, pillars 105 are formed by utilizing an electron beam lithography technique using calixarene of resist for fine processing. One example of the molecular structure of calixarene is shown in the following. Calixarene is used as a resist for the electron beam exposure, and can preferably be utilized as a resist for a nano processing.

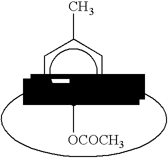

In this case, a silicon substrate having an orientation (100) is used for the substrate 101. First, as shown in FIG. 15(a), a silicon oxide film 185 and a calix [n] arene electron beam negative resist 183 are formed on the substrate 101 in this order. Film thicknesses of the silicon oxide film 185 and the calixarene electron beam negative resist 183 are 40 nm and 55 nm, respectively. Next, a region for forming the pillar 105 is exposed by using electron beam (EB). Development is conducted by using xylene, and rinse is carried out by using isopropyl alcohol. This process provides a patterning of the calixarene electron beam negative resist 183, as shown in FIG. 15(b).

Subsequently, a positive photoresist 155 is applied on the entire surface thereof (FIG. 15(c)). Film thickness thereof is set to 1.8 μm. Thereafter, a mask exposure is conducted so as to expose the region channel 103, and then the development is conducted (FIG. 16(a)).

Then, the silicon oxide film 185 is etched via a reactive ion etching (RIE) with a gaseous mixture of CF₄ and CHF₃. The film thickness after the etching is set to 35 nm (FIG. 16(b)). The resist is stripped by an organic material-washing that utilizes a liquid mixture of acetone, alcohol and water, and thereafter an oxidation plasma processing is conducted (FIG. 16(c)). Subsequently, the substrate 101 is etched by an ECR etching using HBr gas. The film thickness of the silicon substrate after the etching is set to 400 nm (FIG. 17(a)). Subsequently, wet etching is conducted with buffered fluorinated acid BHF to remove the silicon oxide film (FIG. 17(b)). The channel 103 and the pillar 105 are formed on the substrate 101 by the above process.

Here, a hydrophilicity of the surface of the substrate 101 may preferably be conducted, subsequent to the production process of FIG. 17(b). The sample liquid can be smoothly introduced into channel 103 and between the pillars 105 by conducting the hydrophilicity on the surface of the substrate 101. In particular, in the separating portion 107 having fine channels provided by the presence of the pillars 105, it is preferable that introduction of the sample liquid by capillary phenomenon is promoted by providing the hydrophilicity to the surface of the channel to provide improved separation efficiency.

Consequentially, after the production process of FIG. 17(b), the substrate 101 is disposed in a furnace to form a silicon thermal oxide film 187 (FIG. 17(c)). In this occasion, the heat treatment condition is suitably selected such that the film thickness of the oxide film is 30 nm. Difficulty in introducing a liquid into the separation apparatus can be resolved by forming the silicon thermal oxide film 187. Thereafter, an anodic bonding is conducted with a coating 189, and then sealing is provided to complete the separation apparatus (FIG. 17(d)).

Here, when plastic material is used for the substrate 101, the processing can be conducted via a known method that is suitable for the type of the material of the substrate 101 such as etching, press molding using a metal mold such as embossment molding, injection molding, formation by light cure or the like.

It is also preferable to provide the hydrophilicity on the surface of the substrate 101 when a plastic material is used for the substrate 101. The sample liquid can be smoothly introduced into channel 103 and between the pillars 105 by providing hydrophilicity onto the surface of the substrate 101. In particular, in the separating portion 107 having fine channels 103 presented by the pillars 105, it is preferable that introduction of the sample liquid by capillary phenomenon is promoted by providing the hydrophilicity to the surface of the channel 103 to provide improved drying efficiency.

As a surface treatment for providing hydrophilicity, a coupling agent having hydrophilic group, for example, may be applied on the side wall of the channel 103. The coupling agent having hydrophilic group includes, for example, a silane coupling agent having amino group, and more specifically includes N-β(aminoethyl)γ-aminopropylmethyldimethoxy silane, N-β(aminoethyl)γ-aminopropyltrimethoxysilane, N-β(aminoethyl)γ-aminopropyltriethoxysilane, γ-aminopropyltrimethoxysilane, γ-aminopropyltriethoxysilane, N-phenyl-γ-aminopropyltrimethoxysilane and so on. These coupling agents can be applied by spin coating, spraying, dipping, vapor processing or the like.

Furthermore, a treatment for preventing the adhesion can be conducted on the channel 103 to prevent molecules of sample from adhering on the wall of the flow channel. As the treatment for preventing the adhesion, a substance having a structure similar to a phospholipid that constitutes cell walls can be applied on the side wall of the channel 103, for example. By providing such treatment, when the sample includes a bio-component such as protein and so on, denaturation of the component can be prevented, and non-specific absorption of specified component in channel 103 can be inhibited, thereby providing improved recovery rate. As a treatment for providing hydrophilicity and a treatment for preventing from adhesion, for example, Lipidure (registered trademark, product of NOF corporation) can be used. In this case, Lipidure (registered trademark) is dissolved in a buffer solution such as TBE buffer or the like to provide a concentration of 0.5% wt., and the channel 103 internal is filled with this solution and is left as it is for several minutes to provide the treatment on the interior wall of channel 103. Thereafter, the solution is blown off with an air gun or the like to dry the channel 103. Other example of such treatment for avoiding the adhesion may include, for example, applying a fluorocarbon resin onto the side wall of the channel 103.

Then, a method such as physical adsorption process, covalent binding process, for example, can be used as a method for immobilizing the adsorptive substance onto the surface of substrate 101 in the separating portion 107.

When the physical adsorption process is used, a monolayer film of the adsorptive substance is formed and the formed monolayer film can be adsorbed on the surface of the substrate 101 in the separating portion 107, for example.

Furthermore, when the covalent binding process is employed, a modification of the surface of the substrate 101 is conducted to introduce reactive functional group or active group thereon, and then a solution containing the adsorptive substance is in contact with the substrate 101 to provide the adsorptive substance bound onto the surface of he substrate 101. Method for modifying the surface of the substrate 101 may be appropriately selected corresponding to the purposes, and plasma treatment, treatment by ion beam, electron beam treatment or the like may be used, for example. In this occasion, spacer molecules can be immobilized on the surface of the substrate 101 to provide bonding between spacer molecule and the adsorptive substance. The method for immobilizing spacer molecule will be discussed later.

Furthermore, when substrate 101 of a quartz-type glass is used, a coupling agent such as silane coupling agent may be employed to chemically bind the adsorptive substance A onto this surface. When the coupling agent is employed, the coupling agent is applied on the surface of the pillars 105, and then organic functional group contained in the coupling agent is bound to the adsorptive substance A. In such occasion, thiol group, amino group, carboxyl group, aldehyde group or hydroxyl group, which may be included in the adsorptive substance A, for example, may be utilized. For example, when carboxyl group in a ligand is used, immobilization of the ligand onto substrate 101 can be carried out as follows. Substrate 101 is soaked in aqueous solution of silane coupling agent having —NH₂ group. The concentration of the silane coupling agent, for example, is from 0.1% to2.0% both inclusive. Ligandis immobilized onthe substrate 101 that has been surface-treated with the silane coupling agent, by a method employing a condensation reagent such as carbodiimide method, for example. In addition, when the immobilization is conducted, an activator such as N-hydroxysuccinimide may also simultaneously be used as required. Carboxyl group of the ligand is bound to —NH₂ of the silane coupling agent. In this way, separating portion 107 having the adsorptive substance layer 109, which is the layer containing immobilized ligand thereon, is obtained.

Furthermore, a method for precedently biotinylating the adsorptive substance A may also be employed as alternative immobilization method. By being biotinylated, avidin or streptavidin can be immobilized onto the substrate 101, and a specific substance can be selectively adsorbed by interaction between biotin and avidin. In this occasion, since binding constant between avidin and biotin is remarkably high as compared with an ordinary binding constant between antigen and antibody, the specific substance A′ is eluted from the adsorptive substance A and recovered under the condition such that the biotinylated adsorptive substance A is not eluted from avidin or the like that is immobilized on substrate 101.

Immobilizing density of the adsorbent material to the substrate 101 may preferably be sufficiently larger such that the specific substance can be bound to the adsorbent substance. Having such configuration, non-specific adsorption of other substance included in the sample onto the surface of the substrate 101 can be suppressed. In addition in particular, if the adsorptive substance A is low molecular substance and the specific substance A′ is a polymer material having a bulky structure, for example, the immobilizing density thereof may preferably selected so that the prevention of the adsorption or binding of the specific substance A′ with the adsorptive substance A by steric hindrance are inhibited.

Further, as a method for forming the adsorptive substance layer 109, a molecular imprinting can be employed to provide on the surface of the substrate 101 a cast polymer layer that is capable of having a specific substance bound thereon, instead of the method for immobilizing the adsorptive substance. The molecular imprinting is a method for synthesizing a polymer that can recognize a target molecule, in a tailor-made manner in accordance with the target molecule in one step, and more specifically, the method is conducted by the following procedure. First, a functional monomer is bound to a target molecule as a template via covalent bond or non-covalent bond to form a template molecular-functional polymer composite. Here, a monomer having two or more functional groups, which contains a functional group that is capable of being bound to the template molecular and a functional group that is capable of being polymerized such as vinyl group, can be employed as the functional monomer. Next, a cross-linking agent and a polymerization initiator are added to a solution containing the template molecular-functional monomer composite to cause polymerization reaction on the wall surface of the separating portion 107. Then, the template molecular is removed from the polymerized polymer by utilizing degradation such as enzymatic digestion, for example. Then, a specific binding site with the template molecular is formed in the obtained polymer.

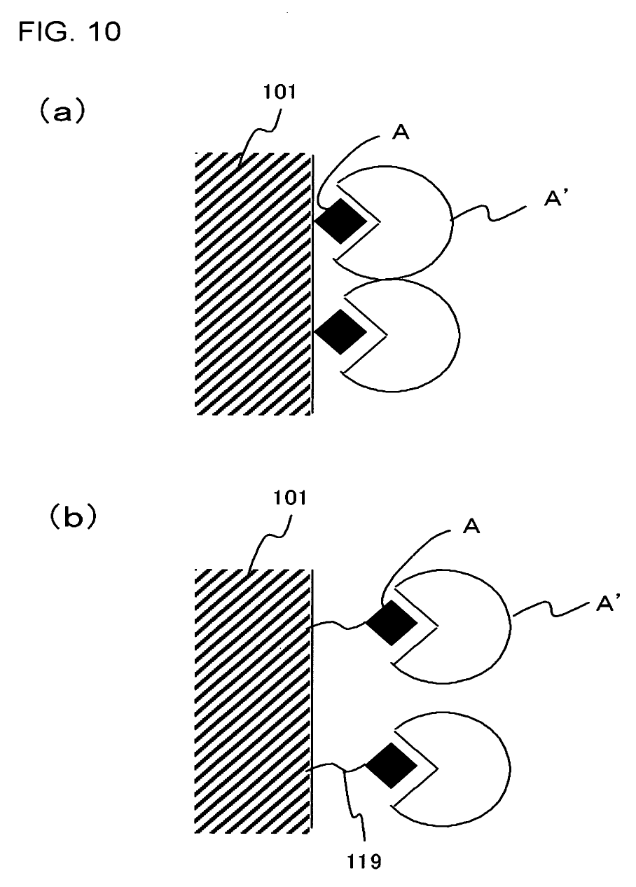

Here, when the adsorptive substance A is chemically bound thereto as mentioned above, a spacer 119 may optionally be provided between the substrate 101 and the adsorptive substance A, as shown in FIG. 10. The spacer 119 is a chemical compound for being inserted between the substrate 101 and the adsorptive substance A, so as to keep the adsorptive substance A apart from the substrate 101, in order to proceed the selective adsorption or binding of the specific substance A′ onto the adsorptive substance A without a steric hindrance. Having such configuration, adsorption or binding of the adsorptive substance A onto the specific substance A′ is facilitated as shown in FIG. 10(a) and FIG. 10(b). In addition, the non-selective adsorption of the non-target components onto the surface of the substrate 101 can be suppressed by employing hydrophilic molecular for the spacer 119. It is preferable that the chain length of the spacer 119 is comparatively shorter. In addition, it is preferable to have an activating group. This is because the immobilizing processing for the adsorptive substance A becomes simpler and easier. The activating group is not particularly limited provided that the functional group is reactive with the adsorptive substance A. When the spacer 119 has no activating group, functional group of the spacer 119 is bound to the adsorptive substance A by using a condensation agent or the like. For example, thiol group, amino group, carboxyl group, aldehyde group, hydroxy group or the like, of the adsorptive substance A may be utilized.

Molecular employed in the affinity chromatography or SPR may be appropriately selected for the spacer 119, and, for example, hexamethylene diamine (HMDA), ethylene glycol diglycidyl ether (EGDG), polyethylene glycol (PEG) having shorter chain length, polyethylene oxide (PEO), or dextran or derivatives thereof may be employed.

Further, in place of the configuration having the adsorptive substance A immobilized onto the surface of the substrate 101, a configuration having a template polymer layer that is capable of having the specific substance A′ bound thereon by molecular imprinting may also be employed.

### Second Embodiment

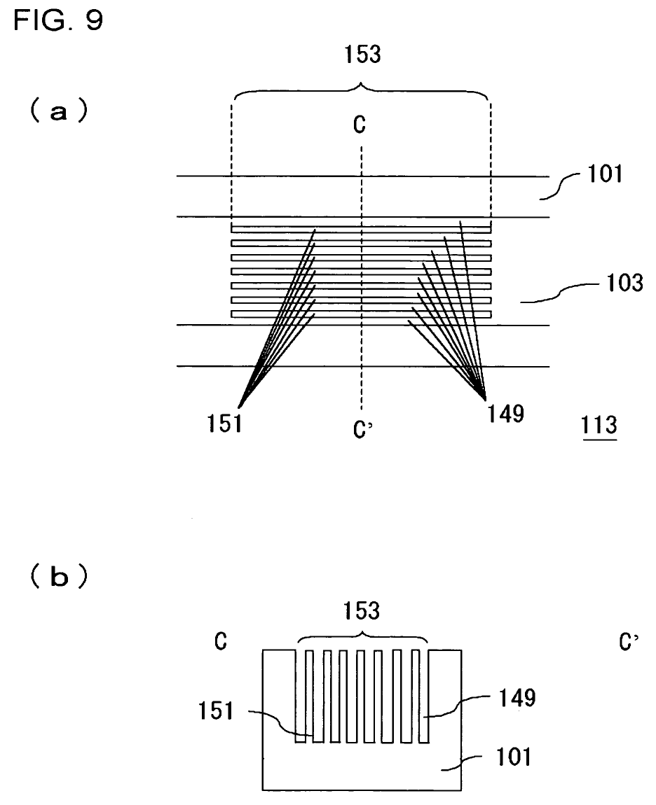

The present embodiment has a configuration, in which the separating portion 107 in the separation apparatus of the first embodiment includes a plurality of fragmentalized channels separated with partition walls. FIG. 9 is a drawing illustrating a configuration of the separating region 113 of the separation apparatus 100 according to the present embodiment. FIG. 9(a) shows a top view, and FIG. 9(b) is a cross-sectional view along C-C direction shown in FIG. 9(a). In the separating portion 153, partition walls 151 are regularly formed at equal intervals in the channel 103, and the liquid flows through the gaps between the partition walls 151. More specifically, the channels having narrower widths than the channel 103 are formed, and thus these fine channels become channels 149 for the separation. Since the adsorptive substance layer 109 is formed on the surface of the channels 149 for the separation similarly as in the first embodiment, the specific substance A′ in the sample liquid can be selectively adsorbed or bound to the nonadsorptive substance A in the channel 149 for the separation.

The separating region 113 of FIG. 9 can be manufactured similarly as in the first embodiment.

### Third Embodiment

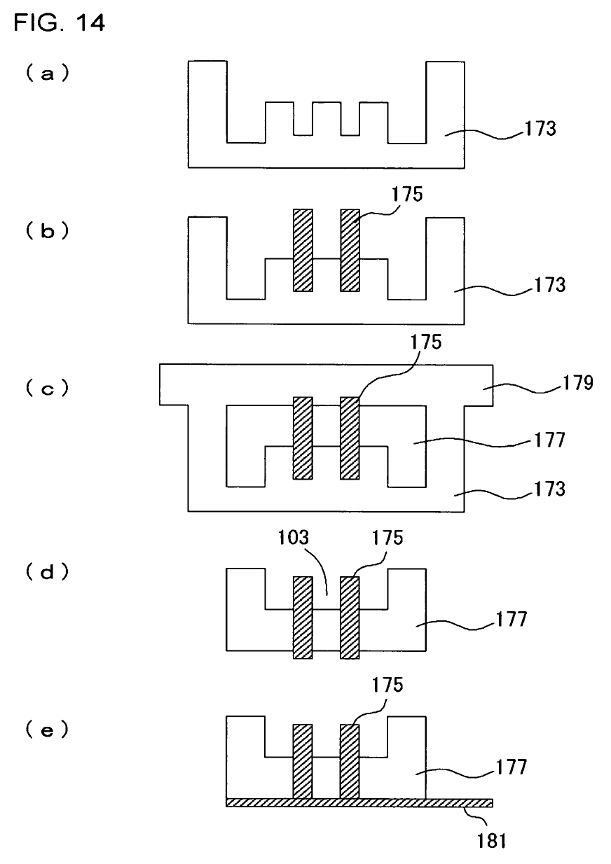

The present embodiment has a configuration, in which electrodes are provided in the interior of the pillar 105 provided in the separating portion 107 in the separation apparatus 100 described in the first embodiment, and an electric potential is applied to the electrodes. An example of a method for forming electrodes inside of the separating portion 107 will be described as follows. FIG. 14 is a process cross-sectional view, illustrating a method for manufacturing a separation apparatus according to the present embodiment. At first, a metal mold 173 having portions for mounting electrodes is prepared (FIG. 14(a)). Then, electrodes 175 are installed into the metal mold 173 (FIG. 14(b)). Material employed for the electrode 175 may be Au, Pt, Ag, Al, Cu or the like, for example. Then, a metal mold 179 for coating is set on the metal mold 173 to fix the electrodes 175, and resin 177 for forming a substrate 101 is injected into the metal mold 173 to conduct a molding (FIG. 14(c)). PMMA is used for resin 177, for example.

Then, the molded resin 177 is demolded from the metal mold 173 and the metal mold 179 for coating to obtain the substrate 101 having the channel 103 formed therein (FIG. 14(d)). Impurities exiting on the surface of the electrode 175 disposed on the back surface of the substrate 101 are removed by an ashing to expose the metallic material of the electrode 175. A metallic film is formed by a vapor deposition onto the bottom surface of the substrate 101, as required, to form an interconnect 181 (FIG. 14(e)). As described above, the separating portion 107 having the electrodes 175 as the pillars 105 is formed in the channel 103. Thus formed electrodes or interconnects 181 are coupled to an external power source (not shown) and are capable of being applied with an electric voltage. After the above described production process, insulating films may be formed on the entire surface of the channel 103. In this occasion, the film thickness of the insulating film is form 10 nm to 500 nm, for example.

Here, in the separation apparatus 100 (FIG. 1), once electrodes are formed in a sample introducing portion 145 and a fluid reservoir 147 by the similar method thereof or the method described in the fourth embodiment, the electrodes can be electrically conducted to the lower surface of the substrate 101 to be coupled to the external power source (not shown), thereby providing an electric voltage between the sample introducing portion 145 and the separating portion 107, between the separating portion 107 and the fluid reservoir 147 and between the sample introducing portion 145 and the fluid reservoir 147, respectively.

Having such configuration, the separation of the target component in the sample can be more certainly conducted with higher efficiency. For example, when the specific substance A′ is a protein and the separation is conducted with a sample that is dissolved in a buffer solution having lower pH than an isoelectric point of this protein, an electric current is applied by using the sample introducing portion 145 as a positive electrode and the separating portion 107 as a negative electrode to lead the protein charged with positive electricity to the separating portion 107 with higher efficiency, thereby selectively being adsorbed to the adsorptive substance layer 109. After removing the other components in the channel 103, an electric current is applied by using the separating portion 107 as a positive electrode and the fluid reservoir 147 as a negative electrode to promote the elution of the protein sustained in the adsorptive substance layer 109 and guiding thereof to the fluid reservoir 147. When the protein sustained in the adsorptive substance layer 109 is eluted, an alternating electric field is provided to increase mobility of protein molecular, thereby further promoting the elution.

Thus, in order to elute the specific substance A′ and the adsorptive substance A, concentration of a salt and concentration of an organic solvent in an eluant flowed in channel 103 can be reduced. Accordingly, when the specific substance A′ is a substance having higher-order structure of protein or the like, the irreversible denaturation of the conformation thereof or the deactivation thereof can be suppressed.

Further, there may be a case that any operation for immobilizing the adsorptive substance A onto the substrate 101 is not required by providing an electric potential to the pillar 105 as an electrode. For example, when the adsorptive substance A is a protein and the receptor thereof is the specific substance A′, and under the pH condition for providing that the protein is negatively charged, the separation of the specific substance A′ can be carried out by the following manner if the ligand is not charged with electricity or positively charged.

First, a solution of the adsorptive substance A, namely the protein, is introduced into the channel 103. In this occasion, since the protein is negatively charged, an electrostatic field is given to the pillars 105 as positive electrodes. Then, the protein is adsorbed to the surface of the pillars 105 by electrostatic interaction. While providing the electrostatic field to the pillars 105, excess protein in the channels 103 is washed away by a buffer solution, and thereafter a sample including the ligand is introduced into the channel 103. Then, the ligand is adsorbed in the protein surface, thereby being separated from other components. Then, similarly as in the first embodiment, after washing the channel 103, salt solution and so forth is introduced therein, such that the ligand is desorbed from the protein and is eventually recovered. In this occasion, since the ligand is eluted while providing the electric field, the condition of the protein being adsorbed onto the surface of the pillars 105 is maintained.

As described above, production process for immobilizing the adsorptive substance A using a coupling agent becomes unnecessary by forming the electrode in the pillar 105, thereby allowing the separation process with further simplicity. Here, even in the case that the protein is positively charged and the ligand is not charged or negatively charged, the ligand can similarly be separated by providing a negative electric potential to the pillar 105.

### Fourth Embodiment

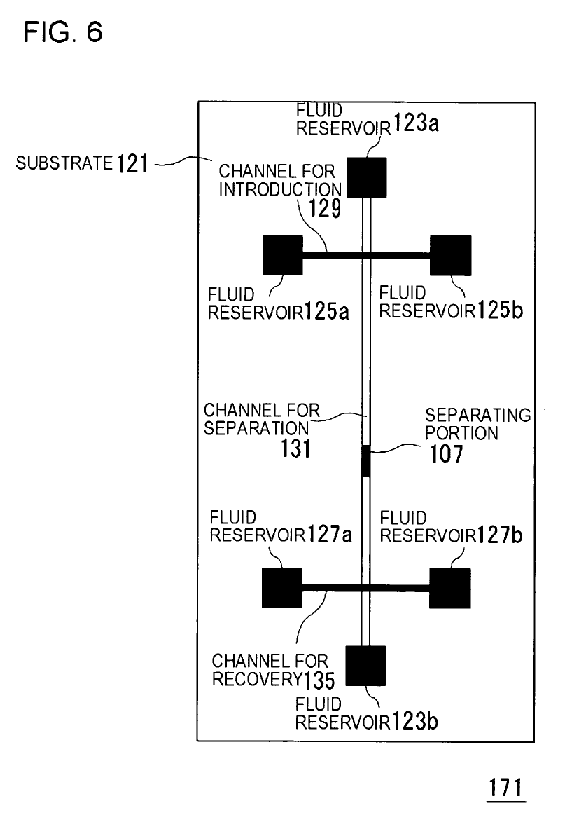

FIG. 6 is a drawing, illustrating a configuration of a separation apparatus 171 according to the present embodiment. In the separation apparatus 171, a channel for separation 131 is formed on a substrate 121, and a channel for introduction 129 and a channel for recovery 135 are formed so as to intersect thereof. The channel for introduction 129, the channel for separation 131 and the channel for recovery 135 have fluid reservoirs 125a and 125b, 123a and 123b, and 127a and 127b formed at the both ends thereof, respectively. Electrodes are provided in the respective fluid reservoirs, and electrical voltage can be applied to both ends of the channel for separation 131, for example, by employing thereof. In addition, a separating portion 107 is provided in the channel for separation 131. The configuration of the separating portion 107 may be any one of the configurations of the first to the third embodiments.

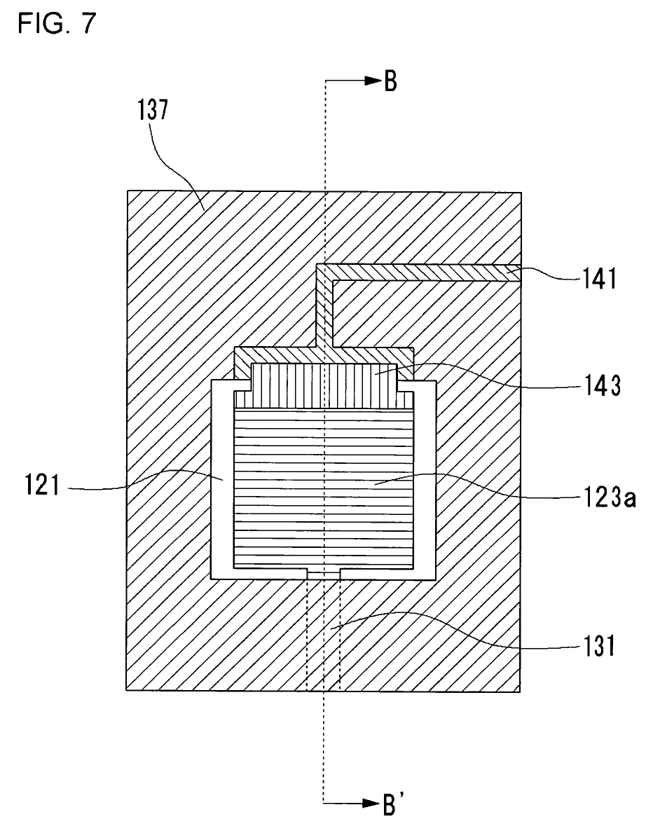

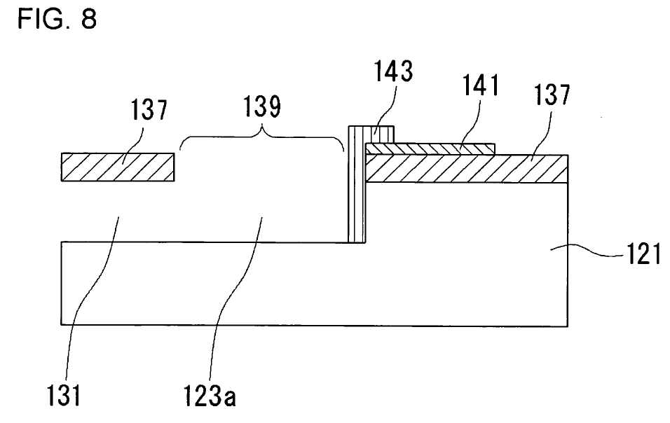

Here, the structure of the fluid reservoir provided with the electrode will be described in reference to FIG. 7 and FIG. 8. FIG. 7 is an enlarged view in vicinity of a fluid reservoir 123a in FIG. 1. In addition, FIG. 8 is a B-B′ cross-sectional view in FIG. 7. A coating 137 provided with an opening 139 for allowing injection of a buffer solution is disposed on the substrate 121 provided with channel for separation 131 and the fluid reservoir 123a. In addition, an electrical conduction path 141 for being coupled to an external power source is arranged on the coating 137. Further, as shown in FIG. 8, an electrode plate 143 is disposed so as to follow along the wall surface of the fluid reservoir 123a and the electrical conduction path 141. The electrode plate 143 and the electrical conduction path 141 are compressively bonded to be electrically coupled. Here, other fluid reservoirs have structures same as the above-described one. The electrode plates 143 formed in the respective fluid reservoirs are capable of being applied with an electrical voltage by providing electric conduction to the lower surfaces of the substrate 101 to couple to an external power source (not shown).

Returning to FIG. 6, a method for conducting a separation of a sample using this apparatus is described. First, a sample including the specific substance A′ is injected into a fluid reservoir 125a or a fluid reservoir 125b. When the sample is injected into the fluid reservoir 125a, an electrical voltage is applied so that the sample flows along a direction toward the fluid reservoir 125b, and when the liquid is injected into the fluid reservoir 125b, an electrical voltage is applied so that the sample flows along a direction toward the fluid reservoir 125a. This flows the sample into the channel for introduction 129, and as a result thereof, the entire channel for introduction 129 is filled. In this occasion, in channel for separation 131, the sample exists only at an intersection thereof with the channel for introduction 129, and a narrower band having a width of on the order of the width of channel for introduction 129 is formed.

Then, the voltage application between the fluid reservoir 125a and the fluid reservoir 125b is stopped, and an electrical voltage is applied between the fluid reservoir 123a and the fluid reservoir 123b so that the sample flows along the direction toward the fluid reservoir 123b. This allows the sample passing through the channel for separation 131. In separating portion 107 disposed in the channel for separation 131, only the specific substance A′ specifically interacts with the adsorptive substance A, and other component is drained to the fluid reservoir 123b. After washing the channel for separation 131 similarly as in the first or the second embodiments, the voltage application between the fluid reservoir 123a and the fluid reservoir 123b is stopped, and instead, an electrical voltage is applied between the fluid reservoir 127a and the fluid reservoir 127b. Then, the band existing at the intersection of the channel for separation 131 and the channel for recovery 135 flows into the channel for recovery 135. The application of the electrical voltage between the fluid reservoir 127a and the fluid reservoir 127b is stopped after a period of duration time is passed, the specific substance A′ contained in the separated band is recovered in the fluid reservoir 127a or the fluid reservoir 127b.

The specific substance A′ is separated by the above-mentioned procedure. Since the separation apparatus 171 comprises the channel for an introduction 129 and the channel for recovery 135, in addition to the channel for separation 131, unnecessary components and the specific substance A′ can be led to different fluid reservoirs, respectively. Thus, contamination of the unnecessary components remained in the fluid reservoir into the specific substance A′ is prevented, thereby further improving the separation efficiency.

In addition, various types of reactions such as enzyme reaction or coloration reaction for detection can be carried out for the specific substance A′ guided into the channel for recovery 135, by introducing a reaction agent into the fluid reservoir 125a or the fluid reservoir 125b.

### Fifth Embodiment

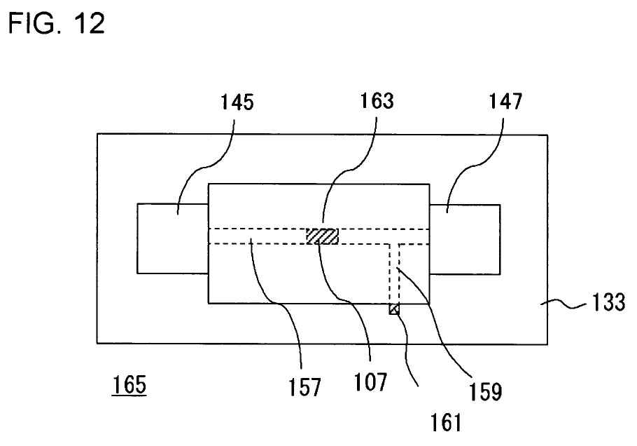

The present embodiment relates to a separation apparatus that is available in conducting a separation, a condensation and a drying of a target component, and is available in utilizing as a substrate for mass spectrometry for offering the dried sample in mass spectrometry. FIG. 12 is a drawing, illustrating a configuration of a separation apparatus 165 according to the present embodiment. The separation apparatus 165 has a basic configuration, which is the configuration of the separation apparatus 100 described in the third embodiment. The substrate 101 in the separation apparatus 100 corresponds to a substrate 133 in the separation apparatus 165 and the channel 103 corresponds to a first channel 157 in the configuration, respectively, and a second channel 159 having narrower width than the first channel 157 is communicated into the first channel 157. A drying section 161 is provided at the end of the second channel 159. A coating 163 is disposed over the upper surfaces of the first channel 157 and the second channel 159, and upper surfaces of a sample introducing portion 145, a fluid reservoir 147, and the drying section 161 forms an opening. Further, similarly as the third embodiment, a metal film (not shown) is provided on the surfaces of the sample introducing portion 145, the fluid reservoir 147, the first channel 157 and the drying section 161, thereby providing a configuration for being applied with an electrical voltage among these.

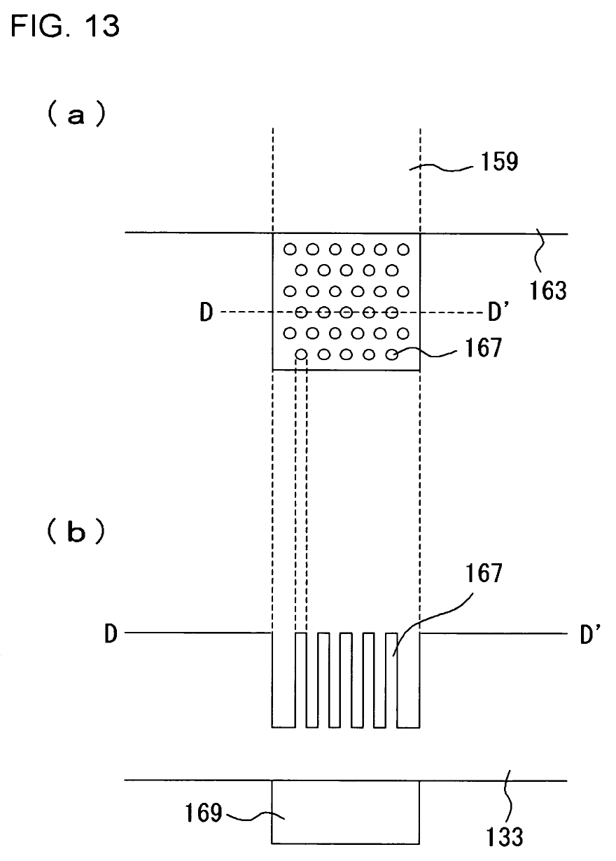

In addition, FIG. 13 is a drawing, illustrating a configuration of the drying section 161 in the separation apparatus 165. FIG. 13(a) is a top view, and FIG. 13(b) is a cross-sectional view along D-D direction of FIG. 13(a). As shown in FIG. 13, a plurality of pillars 167 is included in the drying section 161. In addition, a heater 169 for promoting the drying process is disposed on the bottom surface of the drying section 161.

Operation of the separation apparatus 165 is as follows. First, a sample liquid containing the specific substance A′ is injected from the sample introducing portion 145 and is spreaded to the first channel 157 by utilizing a capillary effect or a pressing using a pump or the like. Then, only specific substance A′ having a specific interaction with the adsorptive substance A is selectively adsorbed to the adsorptive substance layer 109 in the separating portion 107. In this occasion, an electric current is applied by using the sample introducing portion 145 as a positive electrode and the separating portion 107 as a negative electrode to promote guiding the specific substance A′ to the separating portion 107, and thus is preferable. The components that are not adsorbed to the adsorptive substance A is led to a fluid reservoir 147 with a solvent or a liquid that is a solvent or a dispersion medium.

Next, a buffer solution and the like for washing the channel 103 flows through the sample introducing portion 145 to wash thereof, thereby removing the components staying in the first channel 157 except the specific substance A′ staying in the first channel 157. In this occasion, since the specific substance A′ and the adsorptive substance A are adsorbed or bound together by the specific interaction therebetween, these are not dissociated.

Thereafter, the specific substance A′ is desorbed from the adsorptive substance A, similarly as in the first and the second embodiments. In this occasion, an electric current is applied by using the separating portion 107 as a positive electrode and the drying section 161 as a negative electrode and the drying section 161 is heated to a temperature of, for example, 30 degree C. to 70 degree C. by a heater 169, so that a liquid containing the dissociated specific substance A′ is guided through the second channel 159 to the drying section 161, and is immediately dried in the drying section 161. A plurality of pillars 167 are provided in the drying section 161, such that liquid in the second channel 159 is introduced by a capillary phenomenon with higher efficiency and the drying thereof rapidly proceeds. In addition, in this occasion, since the width of the second channel 159 is narrower than that of the first channel 157, a liquid can be introduced from the first channel 157 into second channel 159 with higher efficiency.

As described above, the specific substance A′ separated in the separating portion 107 is dried in the drying section 161 and is eventually recovered.

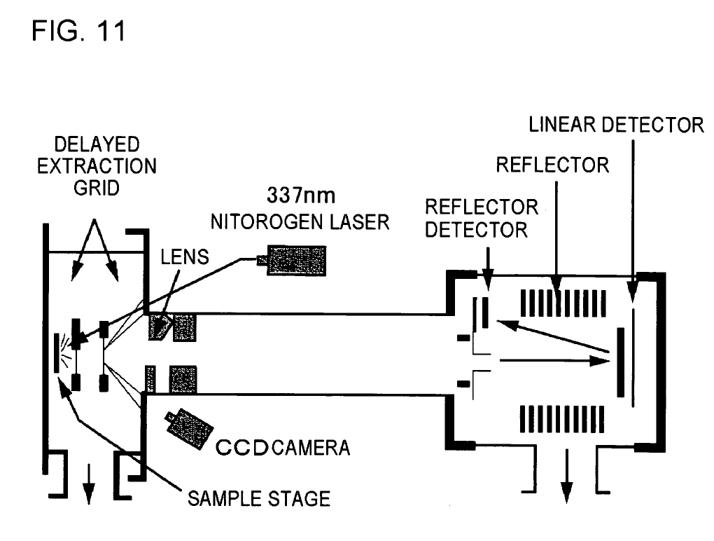

In addition, when the specific substance A′ is dried in the drying section 161, a matrix for a MALDI-TOFMS (Matrix-Assisted Laser Desorption Ionization-Time of Flight Mass Spectrometer) is mixed thereto to obtain a sample for the MALDI-TOFMS. Here, a mass spectrometry apparatus employing in the present embodiment will be briefly described. FIG. 11 is schematic drawing showing a configuration of a mass spectrometry apparatus. In FIG. 11, a dried sample is mounted on a sample stage. Subsequently, a nitrogen gas laser beam having a wave length of 337 nm is irradiated to the dried sample under the vacuum condition. Then, the dried sample evaporates together with the matrix. The sample stage functions as an electrode, and the vaporized sample is flies in the vacuum by applying an electrical voltage, and is detected by a detecting section comprising a reflector detector, a reflector and a linear detector.

Accordingly, after completely drying the liquid within the separation apparatus 165, the separation apparatus 165 is installed in a vacuum tank of a MALDI-TOFMS apparatus, and MALDI-TOFMS can be conducted by utilizing thereof as a sample stage. Here, a metal film is formed on the surface of the drying section 161 to provide a configuration that allows being coupled to an external power source, and thus it functions as a sample stage, through which an electric potential can be applied.

As such, only the specific substance A′ can be separated from the sample containing a plurality of components by employing the separation apparatus 165, and the separated sample is further dried and is eventually recovered. Further, the dried specific substance A can be presented to MALDI-TOFMS in a form of being contained within the separation apparatus 165. Accordingly, since the extraction, the drying and the structural analysis of the target component can be carried out on one piece of the separation apparatus 165, the configuration is also useful for a proteome analysis or the like.

Here, the matrix for MALDI-TOFMS can suitably be selected corresponding to the measuring object substance, and may be selected from, for example, sinapinic acid, α-CHCA (α-cyano-4-hydroxy cinnamic acid), 2,5-DHB (2,5-dihydroxybenzoic acid), a mixture of DHBs (2,5-DHB and 5-methoxy salicylic acid), HABA (2-(4-hydroxyphenyl azo)benzoic acid), 3-HPA (3-hydroxypicolinic acid), dithranol, THAP (2,4,6-trihydroxy acetophenone), IAA (trans-3-indole acrylic acid), picolinic acid, nicotinic acid and the like.

### Sixth Embodiment

The present embodiment relates to a method for conducting a purification of GFP (Green Fluorescent Protein), to which His-Tag (histidine tag) is introduced by using anti-His-Tag (anti-histidine tag) antibody, by employing the separation apparatus 100 described in the first embodiment.

In the separation apparatus 100, anti-His-Tag antibody is immobilized on the surface of the separation portion 107 to form the adsorptive substance layer 109. In order to carry out the immobilization, a method similar to the first embodiment, for example, or a known method related to the immobilization of an antibody for affinity chromatography may be employed.

More specifically, surface treatment of the separating portion 107, for example, is conducted by using a silane coupling agent having —NH₂ group. Then, a spacer is combined to the separating portion 107. EGDE (ethylene glycol diglycidyl ether), for example, is used as a spacer. In order to provide the binding of the spacer, large excess of EGDE, for example, is added to NaOH solution of pH 11 and stirred at, for example, 30 degree C. This solution is dropped onto the separating portion 107 to cause a reaction, for example, for 24 hours. Thereafter, anti-His-Tag antibody is immobilized by utilizing epoxy functional group existing on the end of the spacer. In this occasion, an alkali solution of anti-His-Tag antibody is dropped onto the separating portion 107 having the spacer, and then the dropped portion is left as it is. Then, the separating portion is washed to obtain the separation apparatus 100 having anti-His-Tag antibody immobilized on the separating portion 107.

An extractive including His-Tag-added GFP expressed in Escherichia coli is introduced into the sample introducing portion 145 of the obtained separation apparatus 100. Then, only GFP having His-Tag added thereto selectively interacts with anti-His-Tag antibody, thereby being adsorbed to the adsorptive substance layer 109. After washing the channel 103, a visual observation of the separating portion 107 readily presents a confirmation thereof, since a region having GFP adsorbed thereon emits green fluorescence.

His-Tag-added GFP can be recovered from the fluid reservoir 147 by desorbing thus separated His-Tag-added GFP from the adsorptive substance layer 109, similarly as the first embodiment.

While the present embodiment employs anti-His-Tag antibody, nitrilotriacetic acid or the like may be immobilized to the separating portion 107, similarly as in a case of a His-Tag bonding nickel column. In addition, the purification method of the present embodiment can also be applied to configurations of the separation apparatus described in the second to the fifth embodiments.

### Seventh Embodiment

The present embodiment relates to a method for separating a substance having specific interaction with a metal by employing the separation apparatus 100 described in the first embodiment.

Such separation apparatus is manufactured as follows. Subsequent to the production process shown in FIG. 17(c), a resist film is provided over the entire surface of the substrate 101, and a patterned resist that exposes only a region for forming the separating portion 107 is formed. A metal film is formed on the entire surface of the substrate via the mask of the patterned resist. Material of the metal film is a substance that can be stable within water, such as, for example, Pt and Au. In addition, formation of the metal film is conducted by a vapor deposition, for example. Then, the resist is stripped by using a stripping liquid that is not capable of solving the silicon thermal oxide film 187 but can solve the resist mask, thereby forming a metal film on the surface of the separating portion 107.

Metallic bonding substance can be separated with higher efficiency, by introducing the sample containing the metallic bonding substance into the obtained separation apparatus 100.

When the substance having specific interaction with a metal that is unstable in an aqueous solution, such as, for example, Fe, Cu, Ag, Al, Ni, U, Ge and the like are intended to be separated, a configuration of immobilizing these ions onto the surface of the separating portion 107 by employing a chelate agent, a chelate protein, a crown ether or the like, which is capable of chelating these ions, in a condition of being chelated with these compounds. The immobilization in this case can be conducted by a similar manner as used in the first embodiment. In addition, the separation method of the present embodiment can also be applied to configurations of the separation apparatus described in the second to the fifth embodiments.

### Eighth Embodiment

The present embodiment relates to a method for separating a specified sugar chain in a sample by utilizing lectin as an adsorptive substance A in the separation apparatus 100 described in the first embodiment. Concanavalin A (ConA), for example, is employed as lectin. Lectin is a lectin that is specific with mannose and glucose in the case of employing monosaccharide, and in addition has affinity for glycoprotein having high mannose-type sugar chain and polysaccharide.

In the separation apparatus 100, ConA is immobilized onto the surface of the separating portion 107 to form the adsorptive substance layer 109. In order to carry out the immobilization, a method similar to the first embodiment, for example, or a known manufacturing method related to the immobilized lectin of an antibody for affinity chromatography may be employed.

More specifically, surface treatment of the separating portion 107, for example, is conducted by using a silane coupling agent having —NH₂ group. Then, a spacer is combined to the separating portion 107. Ethylene glycol diglycidyl ether (EGDE), for example, is used as a spacer. In order to provide the binding of the spacer, large excess of EGDE, for example, is added to NaOH solution of pH 11 and stirred at, for example, 30 degree C. This solution is dropped onto the separating portion 107 to cause a reaction for, for example, 24 hours. Thereafter, lectin is immobilized by utilizing epoxy group existing on the end of the spacer. In this occasion, for example, an alkali solution of lectin containing —SH group, —OH group or —NH₂ is dropped onto the separating portion 107 having the spacer provided thereon.

The presence of glycoprotein having high mannose-type sugar chain or polysaccharide can be easily separated with higher accuracy and higher sensitivity and recovered, by using the obtained separation apparatus 100. Since spacer is provided between lectin and the surface of the substrate 101 in the separating portion 107 of the separation apparatus 100, specific interaction between lectin and sugar chain is promoted. Accordingly, the separation can be conducted with higher efficiency. Here, the separation method of the present embodiment can also be applied to configurations of the separation apparatus described in the second to the fifth embodiments.

The present invention has been described above, based on the embodiments. It should be understood by those skilled in the art that these embodiments are presented for the purpose of the illustrations only, and combinations of the components or processes may be modified and changed, and these modifications are within the scope and spirit of the invention.

For example, the separation apparatus according to the present embodiment can alternatively be constituted as follows. FIG. 18 is a drawing, illustrating a configuration of a type of separation apparatus that transfers a sample via the capillary phenomenon. By utilizing the capillary phenomenon, application of an external force such as electric power, pressure or the like is not required, and thus energizing for driving thereof is not required. In FIG. 18, the separating portion described in the first embodiment (not shown) is formed in a channel for separation 540 provided on a substrate 550. An air opening 560 is provided at one end of the channel for separation 540, and a buffer solution inlet 510 for injecting a buffer solution in the occasion of separating is provided at the other end thereof. The channel for separation 540 is tightly sealed except the buffer solution inlet 510 and the air opening 560. A sample quantification tube 530 is connected to a beginning portion of the channel for separation 540, and a sample inlet 520 is provided at the other end of the sample quantification tube 530.

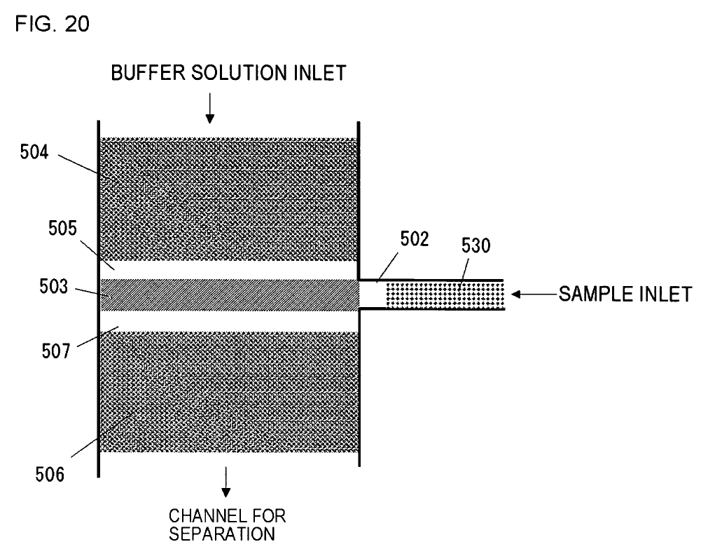

FIG. 20 illustrates an enlarged view of the vicinity of the sample quantification tube 530. Hydrophilic absorption regions are provided in the interior of the sample quantification tube 530, a sample holding portion 503 and a buffer solution introducing portion 504. In addition, an absorption region 506 is provided in vicinity of an introduction opening of the channel for separation 540. A halting slit 502 is provided between the sample quantification tube 530 and the sample holding portion 503. The halting slit 502 may be a hydrophobic region. Each of the absorption regions is separated by halt slits 505 and 507. Air gap volume of the sample holding portion 503 is almost equal to sum of an air gap volume of the sample quantification tube 530 and a volume of the halt slit 502. The width of the halt slit 505 is smaller than the width of the halt slit 502. Here, the sample quantification tube 530 has a hydrophilic function, and is configured to function as a sample introducing portion.

Next, a procedure for separating operation by using the apparatus of FIG. 18 will be described. First, a sample is gradually injected into the sample inlet 520 to fulfill the sample quantification tube 530 therewith. In this occasion, swelling of water surface should be avoided. After the sample quantification tube 530 is filled with the sample, the sample gradually permeates into the halt slit 502. Once the sample permeated to the halt slit 502 arrives at the surface of the sample holding portion 503, all the sample contained within the halt slit 502 and the sample quantification tube 530 is absorbed into the sample holding portion 503 that has larger capillary effect. Here, each of the absorption regions is configured to have different hydrophilic level by suitably selecting the hydrophilic material, and the sample holding portion 503 has large capillary effect than the sample quantification tube 530. The sample never flows into the buffer solution introducing portion 504 during the charging of the sample into the sample holding portion 503, due to the presence of the halt slits 505 and 507

After the sample is introduced into the sample holding portion 503, a buffer solution for separation is injected into the buffer solution inlet 510. The injected buffer solution is temporarily filled in the buffer solution introducing portion 504, so that the interface with the sample holding portion 503 forms a linear line. When the buffer solution is further charged therein, the buffer solution permeates to the halt slit 505, and flows into the sample holding portion 503, and further proceeds beyond the halt slit 507 toward the direction to the channel for separation, while daggling the sample. In this occasion, since the width of the halt slit 502 is larger than the widths of the halt slits 505 and 507, almost no backflow of the sample is occurred even if the buffer solution flows back to the halt slit 502, as the sample have already moved beyond the sample holding portion 503.

The buffer solution for separation further proceeds toward the air opening 560 through the channel for separation by the capillary phenomenon, and the sample is separated in this process. Once the buffer solution for separation reaches the air opening 560, the flow of the buffer solution is stopped. The status of the separation of the sample is measured at the stage of stopping the flow of the buffer solution or at the stage of continuing the movement of the buffer solution.

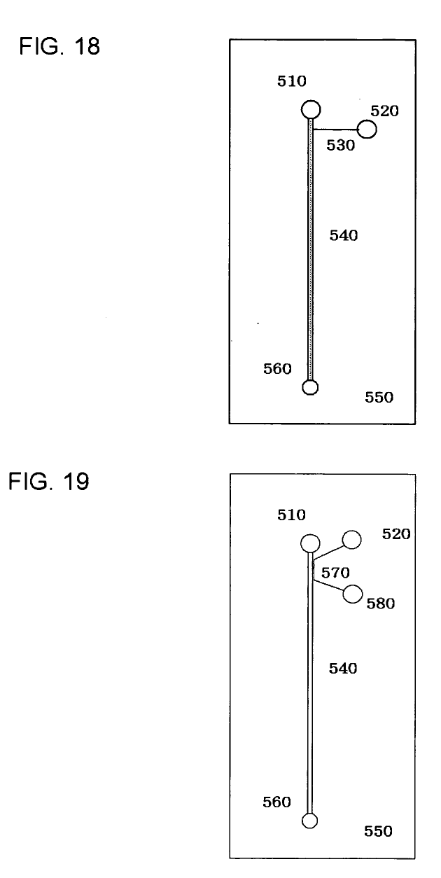

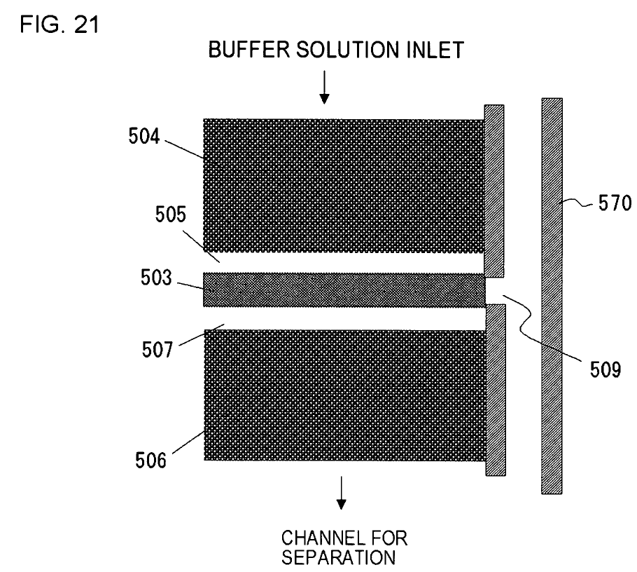

While the above-described embodiment illustrates the example of the separation apparatus utilizing the capillary phenomenon, other example of the sample injection utilizing this phenomenon will be described in reference to FIG. 19 and FIG. 21. In this apparatus, a sample introduction tube 570 is provided, in place of the sample quantification tube 530 in FIG. 18. A sample inlet 520 and an exhaust slot 580 are provided at the both endpoints of the sample introduction tube 570.

Procedure for separation by using this apparatus will be described. First, a sample is injected into the sample inlet 520 to fill therein till the exhaust slot 580 therewith. The sample is absorbed through the introduction opening 509 into the sample holding portion 503 during this operation.

Thereafter, air is pressingly-injected into the sample inlet 520 to exhaust the sample from the exhaust slot 580, thereby wiping out and drying the sample in the interior of the sample introduction tube 570. In the case of separation by the capillary phenomenon, the buffer solution for separation is injected similarly as in the above-described procedure. In a case of separation by an electrophoresis, a buffer solution for migration is introduced from a fluid reservoir corresponding to the buffer solution inlet 510 or from a fluid reservoir corresponding to the air opening 560, before the introduction of the sample. Flow of the sample into the sample holding portion is prevented, due to the presence of the halt slits 505 and 507 that are widely formed.

At the stage that the holding of the sample in the sample holding portion 503 is completed, a very small amount of the buffer solution for migration is further added to a fluid reservoir at one end of the channel for separation or a light vibration is added to a peripheral of the sample holding portion 503 to continue the buffer solution, and then an electrical voltage is applied to separate thereof.

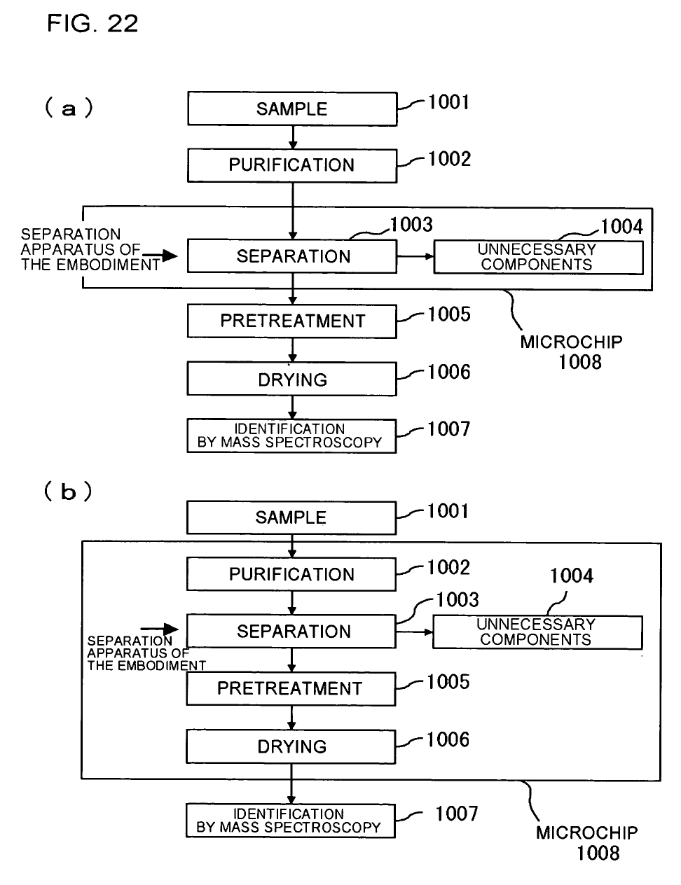

Here, FIG. 22 is a block drawing of mass spectrometry systems, comprising a separation apparatus of the present embodiment. This system comprises units for conducting respective processes of, as shown in FIG. 22(a), a purification 1002 for removing foreign elements in a sample 1001 in a certain level, a separation 1003 for removing unnecessary components 1004, a pretreatment 1005 of the separated sample, a drying 1006 of the sample after the pretreatment, and an identification 1007 by mass spectrometry.

Here, the separation process conducted by the separation apparatus described in the above-mentioned embodiment corresponds to the process of the separation 1003, and carried out on a microchip 1008. In addition, the separation apparatus for removing only huge components such as blood cell, for example, is used in the process of the purification 1002. In the pretreatment 1005, the above-described reduction of molecular weight by using trypsin and the mixture with a matrix are conducted. In the drying 1006, the pre-processed sample is dried to obtain a dried sample for mass spectrometry.

In addition, since the separation apparatus according to the present embodiment has the channel, processes from the purification 1002 to the drying 1006 can be conducted on one piece of the microchip 1008, as shown in FIG. 22(b). The identification of trace amount of a component can be definitely conducted with higher efficiency via the method with less loss by sequentially conducting the processes of the sample on one microchip 1008.

As such, among the processes of the sample shown in FIG. 22, appropriately selected processes or all processes can be conducted on the microchip 1008.

### EXAMPLE

While the present invention will be further described in reference to an example for a combination of DNA and RNA as follows, it should be understood that the present invention is not particularly limited thereto.

The reaction apparatus 100 having the pillars 105 formed on the surface of the channel 103 (FIG. 1) is produced via the method described in the first embodiment. The substrate 101 is constituted of a silicon substrate having (100) surface as its principal surface. The separating portion 107 is provided with the pillars 105 (FIG. 2). The pillars 105 are formed via the method described in reference to FIG. 15 to FIG. 17. Here, an interval p between the pillars 105 is set to be about 200 nm.

Next, concerning the surface of the silicon pillar that is pillar 105, an anti-sense oligonucleotide A for a portion of tpa-1 gene of nematode (C. elegans (Caenorhabditis elegans)) is immobilized onto the silicon pillar surface by employing a coupling agent.
A: 5′-SH-TCGATTTTCAAACCGTTTCC-3′ (Sequence number 1)

Here, 5′ end of the anti-sense oligonucleotide A is modified with SH group.

More specifically, in FIG. 1, N-(2-amino ethyl)-3-aminopropyltrimethoxysilane (EDA), which is a type of aminosilane, is immobilized on the surface of the separating portion 107, as a chemical compound for being bound to thiol group of the anti-sense oligonucleotide A.

In this occasion, the separating portion 107 is immersed in a mixture of concentrate HCl: CH₃OH having a mixing ratio of 1:1 for about 30 minutes, and after being washed with distilled water, immersed in concentrate H₂SO₄ for about 30 minutes. Then, after being washed with distilled water, boiling is carried out in deionized water for several minutes. Subsequently, aminosilane such as 1% EDA (in 1 mM acetic acid aqueous solution) or the like is introduced into the separating portion 107, and the reaction is performed at room temperature for about 20 minutes. This provides that EDA is immobilized on the surface of the separating portion 107. Thereafter, residue is washed out with distilled water, and drying is carried out by heating thereof about 120 degree C. within an inert gas ambient atmosphere for 3 to 4 minutes.

Subsequently, 1 mM solution of succinimidyl 4-(maleimidephenyl)butyrate (SMPB) is prepared as a bifunctional cross linker, and after dissolving in a small amount of DMSO, dilution is carried out. The separating portion 107 is immersed into this diluted solution at room temperature for two hours, and after being washed with diluent solvent, drying is carried out in an inert gas ambient atmosphere.

Having this operation, ester group of SMPB reacts with amino group of EDA to provide a condition, in which maleimide is exposed on the surface of the separating portion 107. In such condition, the anti-sense oligonucleotide A additionally having thiol group is introduced into the separating portion 107. As such, thiol group of the anti-sense oligonucleotide A reacts with maleimide on the surface of the separating portion 107, such that the anti-sense oligonucleotide A is immobilized on the surface of the separating portion 107. (for example, Chrisey et al., Nucleic Acids Research, 1996, Vol.24, No. 15, pp. 3031 to 3039). This allows immobilizing the anti-sense oligonucleotide A on the surfaces of the channel 103 and the pillars 105.

The separation apparatus 100 is thus obtained by the above-mentioned procedure. Separation of RNA is conducted by employing thus obtained separation apparatus 100.

RNA extracted from a nematode is mixed with a hybridization solution. (Rapid hybridization buffer, product of Amersham Biosciences Corp.)

A sample is introduced from the sample introducing portion 145, and reaction is conducted in an humidity conditioning box at 70 degree C. for two hours, and thereafter washings are conducted: with 2×SSC (standard salt citric acid buffer solution) and 0.1% SDS (sodium dodecyl sulfate) at room temperature for 15 minutes; and subsequently with 0.2×SSC and 0.1% SDS at 65 degree C. for 15 minutes. Then, DEPC (diethylprocarbonate) treating water is introduced from the sample introducing portion 145 to conduct a removal of the liquid that is contained in the fluid reservoir 147 by being pushed therein and a washing of the fluid reservoir 147. Then, a denaturation thereof is carried out at 80 degree C., and after separating DNA immobilized onto the separating portion 107 and RNA by quenching, the solution fraction is recovered into the fluid reservoir 147 to obtain a solution containing RNA derived from tpa-1 gene at higher concentration. As such, according to the present example, RNA having the specified sequence can be preferably separated from mixture of RNAs.

1. A separation apparatus, including:
a substrate;
a channel provided in said substrate and for flowing sample in said channel;
a separating portion provided in said channel and for separating a specific substance in said sample; and
a fine channel provided in said separating portion and having a width that is smaller than that of said channel,
wherein a layer of an adsorptive substance is formed in said separating portion, said adsorptive substance selectively adsorbing or binding to said specific substance.

2. A separation apparatus, including:
a substrate;
a channel provided in said substrate and for flowing sample in said channel;
a separating portion provided in said channel and for separating a specific substance in said sample; and
a protruding portion provided in said separating portion,
wherein a layer of an adsorptive substance is formed in said separating portion, said adsorptive substance selectively adsorbing or binding to said specific substance.

3. The separation apparatus according to claim 1 or 2, wherein electrodes are provided in said separating portion and said channel, and said separation apparatus further comprises an electrical voltage applying unit that provides electrical voltage between said electrodes.

4. The separation apparatus according to any one of claims 1 or 2, wherein a protruding portion is provided in said separating portion, and an electrode is formed in said protruding portion.

5. The separation apparatus according to any one of claims 1 or 2, wherein a combination of said specific substance and said adsorptive substance is any one of: an antigen and an antibody; an enzyme and a substrate; an enzyme and a substrate derivative; an enzyme and an inhibitor; a sugar and a lectin; a DNA and a DNA; a DNA and an RNA; a protein and a nucleic acid; a metal and a protein and a ligand and a receptor.

6. The separation apparatus according to any one of claims 1 or 2, wherein said adsorptive substance is provided through a spacer on the surface of said substrate.

7. A separation method, comprising:
in a separating portion of a separation apparatus including a channel provided in a substrate, a separating portion provided in said channel and a fine channel provided in said separating portion and having a width that is smaller than that of said channel,
introducing a liquid containing an adsorptive substance into said channel while applying an electrical voltage of different polarity than that of said adsorptive substance to said separating portion to cause an adsorption onto said separating portion, said adsorptive substance being capable of selectively adsorbing or binding to a separating target substance;
introducing a sample containing said separating target substance into said channel to cause a selective adsorption or binding to said adsorptive substance; and
introducing an eluting solution into said channel to elute and recover said separating target substance, said eluting solution being capable of causing an elution of said separating target substance from said adsorptive substance.

8. A separation method, comprising:
in a separating portion of a separation apparatus including a channel provided in a substrate, a separating portion provided in said channel and a protruding portion provided in said separating portion, introducing a liquid containing an adsorptive substance into said channel while applying an electrical voltage of different polarity than that of said adsorptive substance to said separating portion of said separating apparatus to cause an adsorption onto said separating portion, said adsorptive substance being capable of selectively adsorbing or binding to a separating target substance;
introducing a sample containing said separating target substance into said channel to cause a selective adsorption or binding to said adsorptive substance; and
introducing an eluting solution into said channel to elute and recover said separating target substance, said eluting solution being capable of causing an elution of said separating target substance from said adsorptive substance.

9. A mass spectrometry system, comprising:
a separating unit that separates a biological sample according to molecular size or a property of the biological sample;
a pretreatment unit that conducts a pretreatment including an enzymatic digestion treatment of the sample separated by said separating unit;
a drying unit that dries the pretreated sample; and
a mass spectrometry unit that achieves a mass spectrometry of the sample after drying,
wherein said separating unit contains the separation apparatus according to any one of claim 1 or 2.
